(19) United States
(12) Patent Application Publication
(10) Pub. No.: US 2008/0052212 A1
(43) Pub. Date: Feb. 28, 2008

(54) SECURITIZED INVESTMENT PRODUCT FOR GAINING EXPOSURE TO A FUND OF MANAGED ACCOUNTS

(76) Inventor: William O. WINSAUER, Austin, TX (US)

Correspondence Address: STROOCK & STROOCK & LAVAN LLP, 180 MAIDEN LANE, NEW YORK, NY, 10038, US

(21) Appl. No.: 11/833,776

(22) Filed: Aug. 3, 2007

Related U.S. Application Data
(60) Provisional application No. 60/835,805, filed on Aug. 3, 2006.

(51) Int. Cl. G06Q 40/00

(52) U.S. Cl. 705/36 R

(57) ABSTRACT

A structured investment vehicle includes a master fund having a price being linked to a plurality of managed accounts; an enhanced fund that invests in the master fund on a leveraged basis; and a collateralized fund obligation that gains exposure to the enhanced fund through the purchase of fund-linked certificates associated with the enhanced fund, wherein the collateralized fund obligation finances purchase of the certificates by issuing two or more tranches of securities in which at least one tranche is a debt obligation.

### CROSS-REFERENCE TO RELATED APPLICATIONS

This application claims priority to U.S. Provisional Patent Application No. 60/835,805, filed Aug. 3, 2006, the entire disclosure of which is hereby incorporated by reference.

### BACKGROUND OF THE INVENTION

1. Field of the Invention

The present invention relates to a securitized investment vehicle, commonly referred to as a Collateralized Fund Obligation (CFO), structured to provide leveraged exposure to a fund of managed accounts.

2. Description of the Related Art

CFOs are a variant of a collateralized debt obligation (CDO) that are collateralized or secured directly or indirectly by a portfolio of hedge funds. Because CFOs are typically secured by hedge funds they have specialized risks and limitations that emanate from the nature of hedge funds.

Generally speaking, a hedge fund is a largely unregulated investment vehicle that is a managed fund of securities, debt instruments, and financial contracts. Hedge funds are managed according to the hedge fund manager's investment strategy. The hedge fund manager has little obligation to report his day-to-day operations of the hedge fund. Moreover, the rules of most hedge funds place strict limitations on redemption of an investor's interest in the hedge fund, including in some cases the right to suspend redemption. As such, hedge funds are generally illiquid investment vehicles. Furthermore, because of a lack of transparency in the management of the hedge fund, slippage in the strategy of the hedge fund manager (known as “style drift”) is common. Thus, although hedge funds can achieve a high return on investment (ROI), they are also extremely risky and can result in a loss of principal investment. An in depth discussion of the risk factors associated with hedge funds and, by extension, CFOs secured by hedge funds is explained in an article by Moody's Investors Service, entitled “Moody's Approach to Rating Collateralized Funds of Hedge Fund Obligations,” dated Jul. 10, 2003.

Managed accounts are a different type of investment vehicle in which an investor contracts with a hedge fund manager to manage a portfolio according to the hedge fund manager's strategy, but where the investor retains ownership of the managed account. The investor funds the managed account, but the hedge fund manager controls how the money is invested. This arrangement can be advantageous because the hedge fund manager's investments are transparent to the managed account owner. Moreover, the managed account owner can retain some control over the liquidity of the investments made by the hedge fund manager.

The typical investment structures created have not adequately leveraged the benefits and transparency provided by managed accounts and the structures available in CFO arrangements. Thus, there is a need for a type of investment vehicle that provides exposure (in some cases leveraged exposure) to a number of hedge fund-type investment vehicles that increases transparency and liquidity of the underlying investments.

### SUMMARY OF THE INVENTION

In view of the above discussion, the shortcomings in known hedge funds and CFO's exposed to funds of known hedge funds are overcome, at least in part, by an embodiment of a structured investment vehicle that comprises a master fund in which the price of the master fund is linked to a plurality of managed accounts, an enhanced fund that invests in the master fund on a leveraged basis, and a collateralized fund obligation that gains exposure to the enhanced fund through the purchase of fund-linked certificates associated with the enhanced fund, wherein the collateralized fund obligation finances purchase of the certificates by issuing two or more tranches of securities in which at least one tranche is a debt obligation.

Such a structure, as summarized above, advantageously provides leveraged investments in a diverse portfolio of managed accounts that can theoretically combine a relatively high ROI with an acceptable level of risk through diversification. Because the CFO is backed by a fund-of-fund based on managed accounts, rather than traditional hedge funds, liquidity and transparency are increased. Moreover, in one example, the structure may enable a high level of leverage in the investment vehicle through (1) the leveraged purchase of the master fund by the enhanced fund, and (2) the use of at least one debt obligation to finance the purchase of the fund-linked certificates.

In another embodiment of the structured investment vehicle, two tranches of securities are issued by the CFO to fund the purchase of the fund-linked certificates. One tranche includes one or more debt obligations with stated maturities. A fixed or variable interest rate may be paid on the debt obligations. The second tranche is a class of equities (which may be denominated as notes on shares). As will be discussed in greater detail below, the proportion of the notional value of the first and second tranches determines, at least in part, the amount of leverage obtained in the purchase of the fund-linked certificates.

As an additional feature, the structured investment vehicle may include a method of managing payments of principal and interest on the notes issued by the CFO issuer according to a waterfall arrangement where a priority of payments is established to ensure available funds for both management of the investment vehicle and for payment of principal and interest on the notes.

As can be seen from the foregoing, by the present invention, a novel investment vehicle that enables a leveraged investment in a diversified fund of managed accounts is advantageously provided.

### BRIEF DESCRIPTION OF THE FIGURES

FIG. 1 is a schematic of a structured investment vehicle in accordance with a preferred embodiment of the present invention;

FIG. 2 is an flow diagram of a process for creating a structured investment vehicle in accordance with a preferred embodiment of the present invention;

FIG. 3 is schematic of a transaction in accordance with a preferred embodiment of the present invention;

FIG. 4 is a flow diagram of a preferred embodiment of prioritizing payments for payment dates other than the final payment date; and

FIG. 5 is a flow diagram of a preferred embodiment of prioritizing payments for the final payment date.

### DETAILED DESCRIPTION OF THE PREFERRED EMBODIMENTS

In general, the preferred embodiments of the present invention provide for a novel investment product that permits investors to gain leveraged exposure to one or more managed accounts.

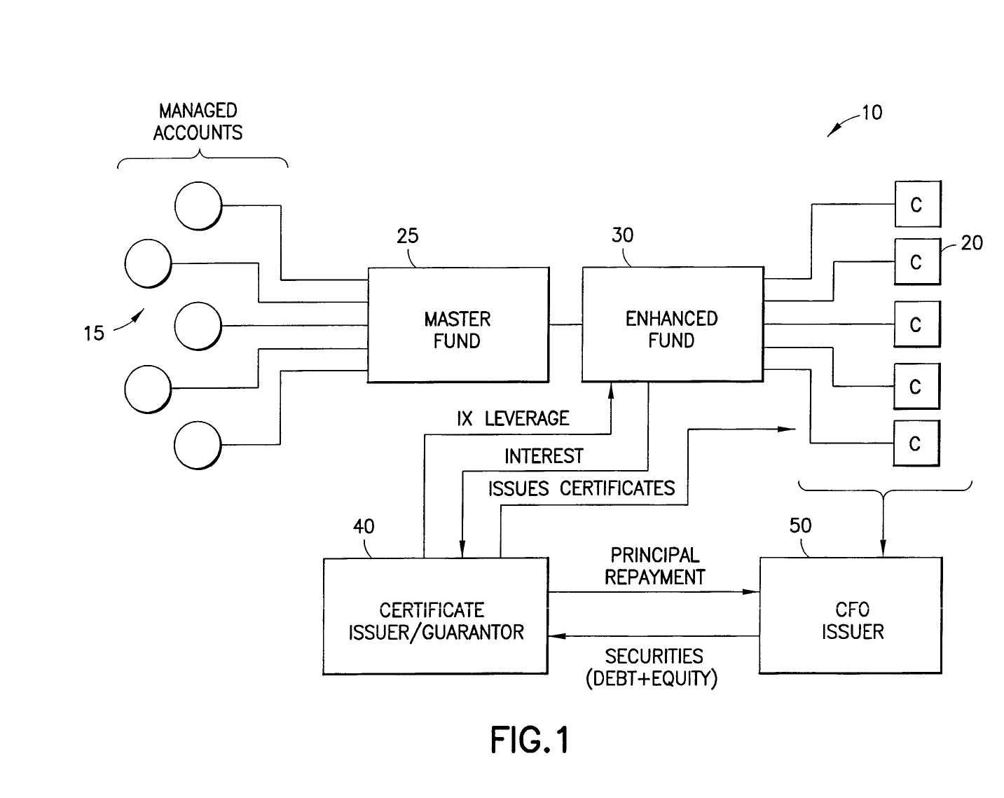

With reference now to FIG. 1, there is shown a preferred embodiment of a structure of an investment product 10 in accordance with the present invention. Investment product 10 provides leverage exposure to one or more managed accounts 15 through the issuance of certificates 20. The managed accounts 15 are preferably accounts managed by fund managers, such as the managers of various known hedge funds, but are not themselves hedge funds. The managed accounts 15 are, therefore, preferably owned and/or controlled by the issuer of the certificates 20 or by a sub-entity created thereby. Alternatively, the managed accounts may be owned and/or controlled by a third party entity. The main distinction between the managed accounts 15 and an interest in a hedge fund being the transparency of management of the managed account 15.

With reference again to FIG. 1, at the foundation of the structure is the managed accounts, which form the basis of the master fund. As noted, the master fund is a fund-of-fund arrangement. The enhanced fund gains leveraged exposure to the master fund through a loan facility. The Certificate Issuer issues and guarantees the fund-linked notes or certificates. The certificates are purchased by the CFO Issuer. To fund the purchase of the certificates, the CFO Issuer issues two tranches of securities—Class A and B notes. The Class A and B notes are available for investment by third party investors. The various levels and structure will now be described in greater detail.

Structure—Master Fund

In structuring the investment product 10, a manager of the investment vehicle 10 selects one or more managed accounts 15 to be included in a master fund 25. The master fund is preferably organized as an Umbrella Unit Trust established under the laws of Jersey (Channel Islands). The initial net asset value (NAV) of the master fund 25 may be designated as $1,000,000 per unit.

The manager of the master fund 25 may select one or more managed accounts 15 according to a predetermined investment strategy. In a preferred embodiment, upon selection by the manager, master fund 25 includes a plurality of managed accounts 15 in a fund-of-funds arrangement representing a diversified portfolio of a selected investment strategy. The manager also preferably allocates and/or weights the managed accounts 15 in the master fund 25 according to the investment strategy. Guidelines for the management and administration of the master fund 25 may be included so as to control the volatility and/or risk exposure of the master fund to any one managed account/fund manager and/or any one type of investment strategy. The following is a series of illustrative guidelines:

(1) minimum of twenty-five (25) trading advisors across diversified strategies;

(2) no single trading advisor represents more than 5% of the aggregate NAV of the master fund; provided that four (4) trading advisors may each represent up to 6% of the aggregate NAV of the master fund; provided further that assets of the master fund that are allocated to a selected “stand alone,” diversified sub-fund may represent more than 6% of the NAV;

(3) no minimum allocation requirement; and

(4) each investment of the master fund in a managed account may not exceed 15% of the NAV of such managed account.

It should be understood, however, that the above guidelines can be re-configured to meet the specific needs and strategy of a particular investment product without deviating from the scope of the present invention.

In a preferred embodiment, the master fund 25 may comprise the allocation set forth in Table I below:

TABLE I

| Strategy | Allocation (100%) |
|---|---|
| Long Short Equity | 29.00% |
| Even Driven | 23.25% |
| Multi-Strategy | 13.25% |
| Managed Futures | 6.25% |
| Fixed Income Arbitrage | 6.00% |
| Emerging Markets | 4.50% |
| Merger Arbitrage | 4.00% |
| Global Macro | 4.00% |
| Convertible Arbitrage | 4.00% |
| Statistical Arbitrage | 3.25% |
| Distressed Securities | 2.50% |

The following descriptions provide further details on the types of strategies incorporated into the allocation of Table I. Convertible Arbitrage strategies attempt to exploit anomalies in prices of corporate convertible securities, such as convertible bonds, warrants and convertible preferred stock. Managers in this category may buy or sell such securities and then hedge some or all of the associated risks. These risks include changes in the price of the underlying stock, changes in expected volatility of the stock, changes in the level of interest rates and changes in the credit standing of the issuer.

Statistical Arbitrage managers use quantitative multi-factor models to identify overvalued and undervalued equity securities while neutralizing the portfolios exposure to market risk by combining long and short positions. Portfolios are typically structured to be market, industry, sector, and dollar neutral. This is accomplished by holding long and short equity positions with roughly equal exposure to the related market or sector factors.

Event Driven strategies focus on identifying investment opportunities that benefit from specific events or market conditions. For instance, in the broader perspective, event-driven strategies often concentrate on taking positions in firms that are or are anticipated to be involved in mergers, restructurings, bankruptcies or other special situations.

Distressed Securities portfolios invest in both debt and equity of companies that are in or near bankruptcy. Because of the relative illiquidity of distressed debt and equity, short sales are difficult, and most funds are primarily long.

Merger Arbitrage seeks to capture the price spread between current market prices of corporate securities and their value upon successful completion of a takeover, merger, spin-off or other types of corporate reorganizations. In merger arbitrage, the opportunity typically involves buying the stock of the target company after a merger announcement and shorting an appropriate amount of the acquiring company's stock.

Long/Short Equity managers hedge at least some portion of their equity market exposure with short sales or exchange-traded futures and options. Historically, these managers have tended to have a net long market exposure. The primary economic sources of return to the strategy (beyond merely holding dividend-generating or otherwise appreciating assets) derive from four characteristics that distinguish them from a traditional long-only strategy:

(1) The ability to hold illiquid assets and capture the corresponding risk premia;

(2) The ability to effectively employ short positions;

(3) The ability to utilize derivative financial instruments (e.g. options, OTC derivatives); and

(4) The flexibility to take advantage of inefficiencies in various segments of the equity markets because they are not required to follow specific benchmarks.

Fixed Income—Mortgage Backed Securities (MBS) Arbitrage strategies involve investing in mortgage backed securities and hedging the securities' exposure to credit, prepayment or interest rate risk. In recent years, new methods have evolved for managers to better handle this risks as well as techniques for a manager to better manage the implied prepayment option implied in mortgage backed securities. Recent changes in the packaging these types of securities has increased the opportunities in these markets.

Global Macro strategies invest by making leveraged bets on anticipated price movements of stock markets, interest rates, foreign exchange and physical commodities. Macro managers employ a “top-down” global approach, and may invest in any markets using any instruments to participate in expected market movements. These movements may result from forecasted shifts in world economies, political fortunes or global supply and demand for resources, both physical and financial. Exchange-traded and over-the-counter derivatives are often used to magnify these price movements.

Managed Futures managers invest in listed financial and commodity futures markets and currency markets around the world. The managers are usually referred to as Commodity Trading Advisors (CTA). Trading disciplines are generally systematic or discretionary. Systematic traders tend to use price and market specific information (often technical) to make trading decisions, while discretionary managers use a judgmental approach.

Emerging Markets managers trade equity or fixed income securities in emerging markets around the world. Because many emerging markets do not allow short selling, nor offer viable futures or other derivative products with which to hedge, emerging market investing often employs a long-only strategy.

A person of skill in the art will recognize that the allocation of the master fund may be allocated differently to achieve a desired investment strategy in accordance with the present invention and need not be limited to the nature, number, or allocation presented in Table I and the descriptions of the investment strategies discussed above.

Structure—Enhanced Fund

Turning again to the structure of investment product 10, in a preferred embodiment, one feature of investment product 10 is that the investor can gain exposure to the master fund 15 on a leveraged basis. In one embodiment, in order to obtain a first level of leveraged investment in the investment product 10, an enhanced fund 30 is established and a loan facility is provided to the enhanced fund 30 for leveraged investment in the master fund 25. The enhanced fund 30 is a sub-fund of the master fund 25. The initial NAV of the enhanced fund may be set at $100,000 per unit, for example.

Leverage is provided to the enhanced fund 30 through a loan facility maintained by a lender. It is preferred that the lender lend an amount equivalent to 100% of the enhanced fund's NAV to permit the enhanced fund 30 to invest 200% of its net assets in the master fund 25, thereby permitting 2-times leveraged exposure to the master fund 25. The loan facility may be capped, as necessary. The interest due on amounts borrowed under the loan facility may be paid directly by the enhanced fund 30. Interest may be structured to accrue on amounts borrowed under the loan facility at a per annum rate of at one-month LIBOR plus or minus some percentage.

Structure—CFO Issuer

In a preferred embodiment, the CFO Issuer is set-up as an exempted company incorporated under the laws of the Cayman Islands. As noted above, the CFO Issuer will preferably acquire leveraged exposure to an actively managed subfund—the master fund 25. The master fund 25 may be structured as a Jersey-organized Umbrella Unit Trust, for example, or other such type of trust that has similar characteristics and tax advantages. The trust, in order to effectuate the selected investment strategy, is composed of one or more of the managed accounts and, in this example, one or more customized, stand-alone “fund of funds.”

The CFO Issuer acquires its exposure to the enhanced fund 30 by purchasing fund-linked certificates 20 issued by the Certificate Issuer. Each certificate 20 preferably represents the right to receive from the Certificate Issuer and/or Guarantor on or prior to the maturity date an amount equal to the then-current net asset value (NAV) of the corresponding unit of the enhanced fund. The Certificate Issuer and/or Guarantor will preferably have a high credit rating from Moody's, Standard & Poor's, or other like credit rating agency. Furthermore, in a preferred embodiment, the Certificates are structured to include, without limitation, the terms set forth in Table II below:

TABLE II

| | |
|---|---|
| Type: | Fund-Linked Certificate |
| Underlying Fund: | Enhanced Fund |
| Issue Date: | , 2006* |
| Trade Date: | , 2006* |
| Maturity Date: | , 2013* |
| Currency: | USD |
| Issue Size: | $625,000,000 |
| Denomination | $100,000 |
| Minimum Trading | $1,000,000 |
| Issue Price: | 100% of Denomination per Certificate |

*Dates are configurable as required by investment strategy

In order to improve the liquidity of the Certificates 30, a liquidity commitment may be provided by the Certificate Issuer and/or Guarantor with the issuance of the Certificates 30. As an example of such a liquidity commitment, at any time prior to the maturity date for the Certificates 30, a weekly liquidity program where certificates may be redeemed may be instituted for the Certificates 30, subject to the liquidity of the underlying managed accounts.

Structure—Class A and B Notes

In order to gain a second level of leveraged exposure to the Enhanced Fund 30, the CFO Issuer may fund its purchase of the Certificates 20 by issuing two or more tranches of securities. The senior tranche (or Class A securities) may, for example, be assigned a rating of at least “Aa3” or its equivalent. The more junior tranches (or Class B securities) may be assigned ratings below investment grade or may not be rated at all. Additional credit enhancement will be provided by one or more reserve accounts that will be funded during the course of the transaction using funds obtained by the monetization of excess NAV in the Enhanced Fund, as described below. The senior securities issued by the CFO Issuer will be entitled to receive semi-annual (e.g., quarterly) payments of interest, for the payment of which the Issuer will tender the Certificate Issuer an amount of Certificates 20, for redemption at the then-current NAV, sufficient to generate the funds required to make the related payments. The Certificates 20 will mature on a date approximately seven (7) years after the Certificate issuance date. If the Certificates 20 have not been redeemed prior to the maturity date, the Certificate Issuer (or the Guarantor) will redeem all outstanding Certificates 20 at the then-current NAV.

TABLE III(a)

| | |
|---|---|
| Type: | Class A [Fixed] Rate Fund-Linked Notes |
| Underlying Fund: | Enhanced Fund |
| Issue Date; | , 2006* |
| Trade Date: | , 2006* |
| Maturity Date: | , 2013* |
| Currency: | USD |
| Issue Size: | $250,000,000 |
| Denomination | $1,000,000 |
| Minimum Trading | $1,000,000 |
| Issue Price: | 100% |
| Rating: | Aa3 or higher |

*Dates are configurable as required by investment strategy

TABLE III(b)

| | |
|---|---|
| Type: | Class B [Fixed] Rate Fund-Linked Notes |
| Underlying Fund: | Enhanced Fund |
| Issue Date: | , 2006* |
| Trade Date: | , 2006* |
| Maturity Date: | , 2013* |
| Currency: | USD |
| Issue Size: | $62,500,000 |
| Denomination | $1,000,000 |
| Minimum Trading | $1,000,000 |
| Issue Price: | 100% |
| Rating: | Below Investment Grade |

*Dates are configurable as required by investment strategy

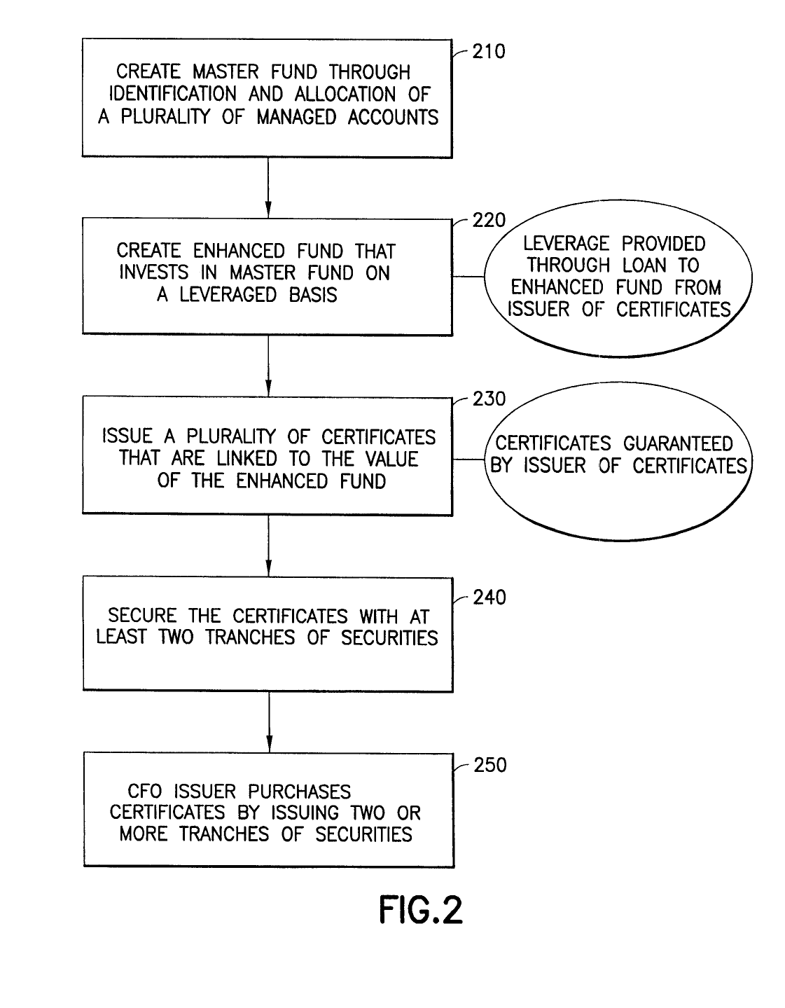

With reference now to FIG. 2, there is shown a preferred embodiment of a method of structuring an investment product in accordance with the present invention. In step 210, a master fund is create through identification and allocation of a plurality of Managed Accounts. In step 220, an enhanced fund is created that invests in the master fund on a leveraged basis, as preferably described herein. In step 230, a plurality of certificates that are linked to the value of the enhanced fund are issued. In step, 240, the certificates are secured by at least one tranche of securities, such as class A and B notes, issued by the CFO issuer. In step 250, the CFO issuer purchases the certificates with the tranches of securities.

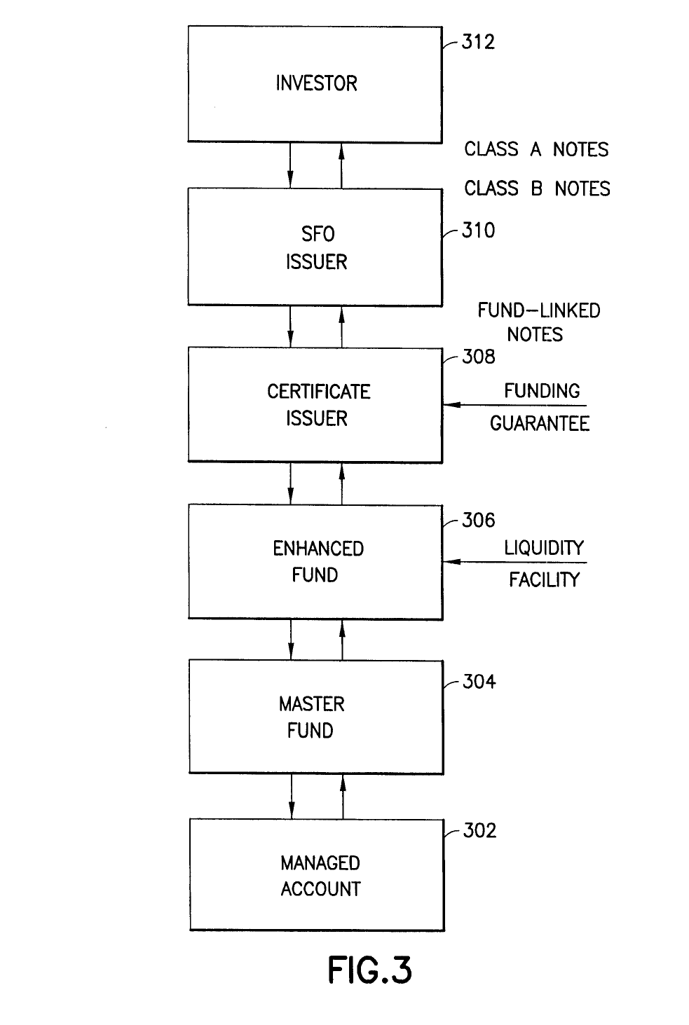

With reference now to FIG. 3, there is shown a preferred embodiment of the relationship of various parties to the investment product of the present invention. As can be seen, a number of managed accounts 302 are incorporated or indexed into a master fund 304. An enhanced fund 306 gains exposure to the master fund 304 preferably through a loan facility. The certificate issuer 308 issues certificates linked to the enhanced fund 306 and also preferably guarantees payment on the certificates. The CFO issuer 310 purchases the certificates from the certificate issuer 308 by issuing a one or more tranches of securities. The investor 312 can purchase the certificates.

Structure—Operation of Investment Product

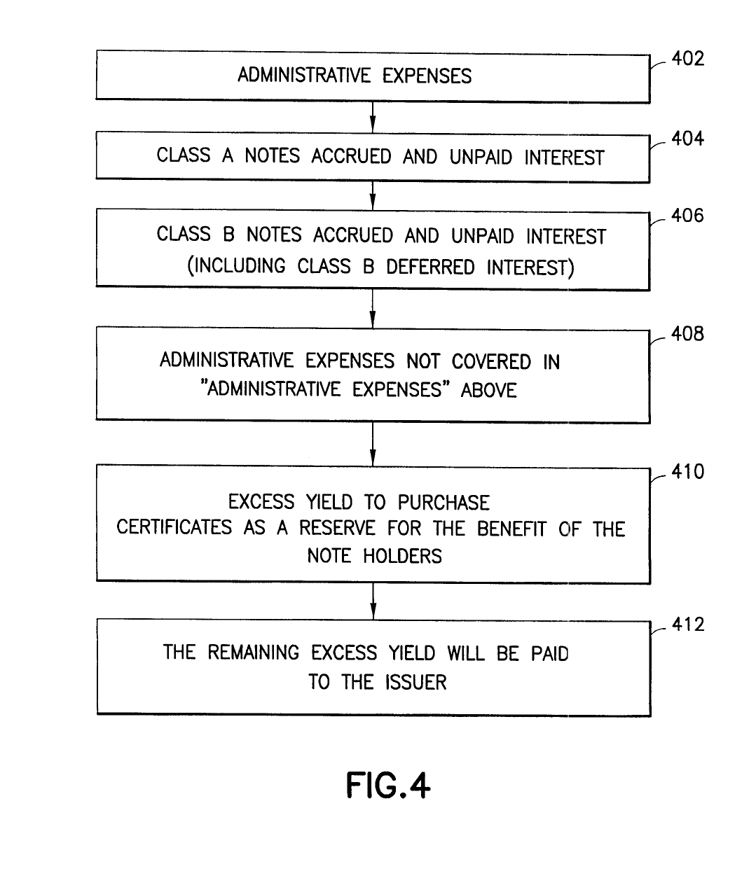

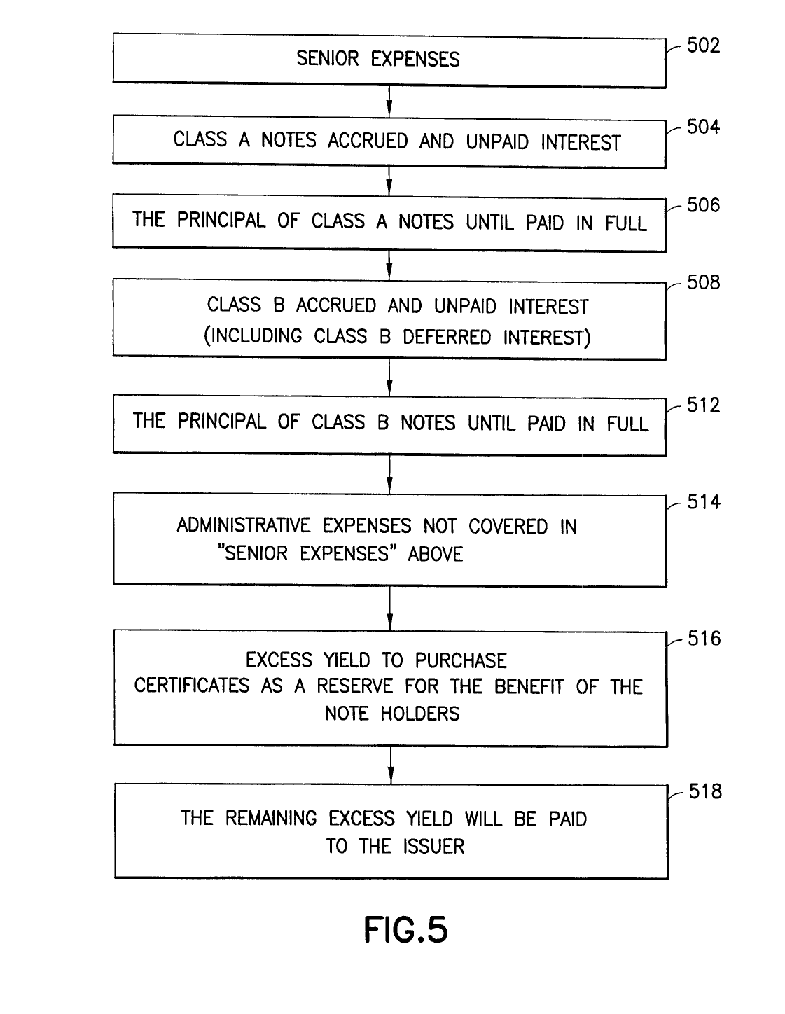

With reference now to FIGS. 4 and 5, there is shown a preferred embodiment of administering the investment product and, in particular, the waterfall of payments to be made on the Class A and B notes. The Class A notes are preferably structured so as to bear interest at a fixed rate per annum. The Class B notes may be similarly structured so as to bear interest at a fixed rate per annum equal. In light of the lower rating, and therefore greater potential risk of repayment, the Class B notes will typically, but not necessarily, pay a higher interest rate than the Class A notes. As an alternative, either for the Class A or B notes, the notes may be structured such that they bear interest on a floating basis. Such floating notes may be swapped for fixed rate notes such that the CFO structure realizes a fixed interest rate. Additionally, the Class B notes, for example, can be structured as preference shares.

In a preferred embodiment, interest on the notes is computed on the basis of a 360-day year of twelve 30-day calendar months. In the present embodiment, no payment of interest on the Class B notes will be made until all accrued and unpaid interest on the Class A notes due on or prior to the payment date has been paid in full. So long as any interest on Class A notes is outstanding, any interest due on the Class B notes which is not available to be paid on any payment date as a result of the operation of the priority of payments an example of which is shown in FIGS. 4 and 5—is deferred and added to the aggregate outstanding balance of the Class B notes. This interest is referred to as “Class B Deferred Interest” and is not to be considered due and payable until the payment date on which such Class B Deferred Interest is available to be paid in accordance with the priority of payments.

In light of the above, a preferred embodiment of prioritizing the payments will now be described in connection with FIG. 4. Payments of principal and interest on the notes on any payment date are made from “Available Funds” in accordance with a priority of payments or waterfall of payments. As used herein, “Available Funds” with respect to any payment date includes (i) net proceeds (net of any liquidity fees and/or early termination fees, for example) from the redemption of Certificates tendered to the CFO Issuer, and (ii) funds held in reserve accounts that are available on such payment date for the applicable payment.

The following definitions are applicable to the operation of the priority of payments: “Final Payment Date” means the earlier of: (i) the stated maturity date of the notes, or (ii) the date of a redemption in whole of notes by reason of an event causing early liquidation or an acceleration of maturity of the notes following an event of default or otherwise. “Administrative Expenses” means fees and expenses of the CFO Issuer, including, without limitation: (a) the fees and reimbursable expenses of the Trustee; (b) other operating expenses of the CFO Issuer, including administrator's fees, registered office fees of the CFO Issuer, any registration fees and taxes of the Issuer and any other fees and expenses of the CFO Issuer, the costs of preparing and distributing reports, giving notices, accounting audits, legal fees and other administrative expenses; (c) fees and expenses of each rating agency (such as Moody's and Standard & Poor's) in connection with any rating of the notes; and (d) fees or expenses of any other person or entity permitted under the indenture and other transaction documents. The term “Expense Cap” refers to, for each payment date, the “Semi-Annual Expense Cap” per payment date plus any unused Semi-Annual Expense Cap from the immediately preceding payment date. The expense cap may be determined according to standard procedures such that a desired rating for the notes is achieved.

In accordance with a preferred embodiment, and with reference to FIGS. 4 and 5, payments are made on each payment date, other than the Final Payment Date, as defined above, in the following priority:

First, Administrative Expenses, as defined above, for the related payment period in an amount not to exceed the Expense Cap “Senior Expenses” are paid (402);

Second, any accrued and unpaid interest on the Class A notes is paid (404);

Third, any accrued and unpaid interest on the Class B notes (including Class B Deferred Interest) is paid (406);

Fourth, Administrative Expenses incurred which are then payable, to the extent such Administrative Expenses were not paid pursuant to the first of the priority of payments above are paid (408);

Fifth, a percentage of the Excess Yield is deposited in a reserve account for the benefit of the note holders is paid (410); and

Sixth, the remaining Excess Yield is paid to the CFO Issuer (412).

On the Final Payment Date, in accordance with a preferred embodiment, payments are made in the following priority:

First, Senior Expenses are paid (502);

Second, any accrued and unpaid interest on the Class A notes is paid (504);

Third, the principal of the Class A notes is paid until paid in full (506);

Fourth, any accrued and unpaid interest on the Class B notes (including Class B Deferred Interest) is paid (508);

Fifth, the principal of the Class B Notes is paid until paid in full (512);

Sixth, Administrative Expenses incurred which are then payable, to the extent such Administrative Expenses were not paid pursuant to the first of the priority of payments above are paid (514);

Seventh, Excess Yield to purchase certificates is held as a reserve (516); and

Eight, the remaining Excess Yield will be paid to the CFO Issuer (518).

In light of the foregoing, it will be seen that there is a novel investment product and structure that uses over collateralization to secure exposure (and, in some embodiments, leveraged exposure) via issued certificates to one or more managed accounts in the form of a fund of funds.

Thus, while there have been shown and described fundamental novel features of the invention as applied to the embodiments thereof, it will be understood that omissions and substitutions and changes in the form and details of the disclosed invention may be made by those skilled in the art without departing from the spirit of the invention. It is the intention, therefore, to be limited only as indicated by the scope of the claims appended hereto.

1. A structured investment vehicle, comprising:
a master fund having a price being linked to a plurality of managed accounts;
an enhanced fund that invests in the master fund on a leveraged basis; and
a collateralized fund obligation that gains exposure to the enhanced fund through the purchase of fund-linked certificates associated with the enhanced fund, wherein the collateralized fund obligation finances purchase of the certificates by issuing two or more tranches of securities in which at least one tranche is a debt obligation.

2. The structured investment vehicle of claim 1, wherein two tranches of securities are issued to fund the purchase of the fund-linked certificates.

3. The structured investment vehicle of claim 2, wherein a first tranche includes one or more debt obligations with stated maturities and a second tranche is a class of equities.

4. The structured investment vehicle of claim 1, wherein a fixed interest rate is paid on the debt obligations.

5. The structured investment vehicle of claim 1, wherein a variable interest rate is paid on the debt obligations.

6. A method of managing payments of principal and interest in a structured investment vehicle, the method comprising:
providing a structured investment vehicle including (i) a master fund having a price being linked to a plurality of managed accounts, (ii) an enhanced fund that invests in the master fund on a leveraged basis, and (iii) a collateralized fund obligation that gains exposure to the enhanced fund through the purchase of fund-linked certificates associated with the enhanced fund, wherein the collateralized fund obligation finances purchase of the certificates by issuing two or more tranches of securities in which at least one tranche is a debt obligation;
paying principal according to a first waterfall arrangement establishing a priority of payments; and
paying interest according to a second waterfall arrangement establishing a priority of payments.
